(19) United States
(12) Patent Application Publication
(10) Pub. No.: US 2023/0166486 A1
(43) Pub. Date: Jun. 1, 2023

(54) LINERS FOR BULK CONTAINERS

(71) Applicant: AMCOR FLEXIBLES NORTH AMERICA, INC., Neenah, WI (US)

(72) Inventors: Scott J. Kelly, Neenah, WI (US); Natalie M. Studer, Neenah, WI (US)

(21) Appl. No.: 17/919,122

(22) PCT Filed: Jun. 30, 2021
(86) PCT No.: PCT/US2021/039776

§ 371 Date: Oct. 14, 2022

Related U.S. Application Data
(60) Provisional application No. 63/070,239, filed on Aug. 25, 2020.

(51) Int. Cl. B32B 27/30; B32B 27/34; B32B 27/32

(52) U.S. Cl. CPC B32B 27/306; B32B 27/34; B32B 27/32; B32B 2250/24; B32B 2307/7244; B32B 2307/546; B32B 2439/40

(57) ABSTRACT

Described are liners for bulk containers that are abuse resistant The liners include at least one sidewall that includes an exterior ply and an interior ply. The interior ply includes a propylene alpha-olefin copolymer that includes a density in a range from 0.865 g/cm³ to 0.900 g/cm³, The interior ply includes the propylene alpha-olefin copolymer in an amount from 5% to 50% by weight of the interior ply.

### TECHNICAL FIELD

The present disclosure relates to liners for bulk containers such as bag-in-box containers, drums and rigid, intermediate bulk containers (IBC) that are especially abuse resistant, i.e., resistant to flex-cracking. The liners include a propylene alpha-olefin copolymer.

### BACKGROUND

Industrial packaging of products in bulk containers, such as bag-in-box formats, drums or IBCs, includes, but is not limited to such items as liquified vegetables, condiments, wine, milk, fruit juice, pharmaceutical liquids, oil (e.g., food oils, such as vegetable oil, or industrial oils, such as motor oil), syrups, solid products in granular or powder form or a combination of liquid and solid products. Liners used with bulk containers are subjected to many stresses. For example, liners may have smaller volumes that include 4 liters (1 gallon), larger volumes, such as 208 liters (55 gallons), or even volumes as great as or greater than 1,136 liters (300 gallons) where the weight of the products in the liner at these volumes can fatigue the liner materials. Transportation of the filled liners may cause further damage to the liner. In situations where the liner contains liquid products, the liner is susceptible to flex-cracking at the gas-liquid interface that is referred to as a shore line. The shore line constantly changes during shipment due to movement and/or vibrations that cause the liquid to move about or slosh. The constant liquid movement in the vicinity of the shore line further fatigues the liner material such that flex-cracking can occur, which contributes to liner leakage.

One attempt to reduce flex-cracking includes the use of dunnage when transporting liners in containers such as drums or IBCs. Dunnage is packing material that is placed between the liner and the top of the container. Dunnage causes the liner to fit tightly in the container such that flex-cracking at the shore line and liner leakage may be reduced. The use of dunnage is disadvantageous due to the additional cost of the dunnage material and the cost of extra labor needed to place the dunnage material into the container.

### SUMMARY

The present application discloses a liner for a bulk container that can provide improved flex-crack resistance and that can be used without dunnage. The liner includes a propylene alpha-olefin copolymer.

In one embodiment, the liner includes a sidewall. The sidewall includes an exterior ply and an interior ply. The interior ply includes a propylene alpha-olefin copolymer that includes a density in a range from 0.865 g/cm³ to 0.900 g/cm³. The interior ply includes the propylene alpha-olefin copolymer in an amount from 5% to 50% by weight of the interior ply.

Other features that may be used individually or in combination with respect to the embodiment are as follows.

The liner may include a fitment attached to the sidewall.

The liner interior ply may include a first polyethylene comprising low density polyethylene, linear low density polyethylene, very low density polyethylene, ultra-low density polyethylene, medium density polyethylene, high density polyethylene, metallocene linear low density polyethylene or blends thereof.

The liner may include a flex crack failure time of greater than 300 minutes according to ASTM D 999-08, Method A2, as described herein.

The liner may include an intermediate ply positioned between the exterior ply and the interior ply and adhesion between adjacent plies includes from 0 g/25.4 cm to 50 g/25.4 cm (0 g/in to 50 g/in) according to ASTM F 904-98.

The intermediate ply may include a propylene alpha-olefin copolymer in an amount from 5% to 50% by weight of the intermediate ply.

The exterior ply, the interior ply and the intermediate ply may be multilayered.

The exterior ply, the interior ply or the intermediate ply may be produced by coextrusion.

The exterior ply, the interior ply or the intermediate ply may include a laminated film.

The exterior ply, the interior ply or the intermediate ply may include an oxygen barrier comprising ethylene vinyl alcohol copolymer or polyamide.

In another embodiment, the liner may include a first sidewall that includes a first exterior ply and a first interior ply and a second sidewall that includes a second exterior ply and a second interior ply. The first interior ply includes a first propylene alpha-olefin copolymer that includes a density in a range from 0.865 g/cm³ to 0.900 g/cm³ in an amount of 5% to 50% by weight of the first interior ply. The second interior ply includes a second propylene alpha-olefin copolymer that includes a density in a range from 0.865 g/cm³ to 0.900 g/cm³ in an amount of 5% to 50% by weight of the second interior ply.

Other features that may be used individually or in combination with respect to the embodiment are as follows.

The liner may include a fitment attached to the first sidewall.

The liner may include a flex crack failure time of greater than 500 minutes according to ASTM D 999-08, Method A2, as described herein.

The liner may include a first intermediate ply positioned between the first exterior ply and the first interior ply wherein the adhesion between any adjacent ply includes from 0 g/25.4 cm to 50 g/25.4 cm (0 g/in to 50 g/in) according to ASTM F 904-98.

The liner may include a second intermediate ply positioned between the second exterior ply and the second interior ply wherein the adhesion between any adjacent ply includes from 0 g/25.4 cm to 50 g/25.4 cm (0 g/in to 50 g/in) according to ASTM F 904-98.

The first intermediate ply and the second intermediate ply each may include a propylene alpha-olefin copolymer in an amount from 5% to 50% by weight of the first intermediate ply and the second intermediate ply.

There are several other aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying figures.

FIG. 1 illustrates a schematic top view of an embodiment of a liner for a bulk container that includes a sidewall;

FIG. 2 illustrates a cross-sectional view of an embodiment of a liner sidewall;

FIG. 3 illustrates a cross-sectional view of an embodiment of a liner sidewall;

FIG. 4 illustrates a cross-sectional view of an embodiment of a liner sidewall;

FIG. 5 illustrates a cross-sectional view of an embodiment of a liner sidewall;

FIG. 6 illustrates an exploded view of an embodiment of a liner that includes a first sidewall and a second sidewall;

FIG. 7 illustrates a schematic top view of an embodiment of a liner for a bulk container that includes a first sidewall and a second sidewall; and

FIG. 8 illustrates a cross-sectional view of a liner first sidewall and second sidewall.

The figures show some but not all embodiments. The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

A liner for bulk containers is described herein. The liner includes at least one sidewall that minimally includes an exterior ply and an interior ply. The interior ply includes a propylene alpha-olefin copolymer comprising a density in a range from 0.865 g/cm³ to 0.900 g/cm³. The sidewall may further include an optional intermediate ply or a plurality of optional intermediate plies. Any intermediate ply may further include the propylene alpha-olefin copolymer comprising a density in a range from 0.865 g/cm³ to 0.900 g/cm³. Each ply includes a film structure.

The term “sidewall”, as used herein, refers to a structure including at least two discrete plies of polymer film. A sidewall may be sealed to itself or another sidewall to form a bag (e.g., minimally an exterior ply and an interior ply).

The term “ply”, as used herein, refers to a building block of liner sidewalls that may be supplied as a polymer film.

The term “exterior ply”, as used herein, refers to the portion of the liner sidewall that is exposed to wear and tear from environment outside of the liner. The exterior ply is furthest away from a product that is packaged in the liner. The exterior ply is in contact with an internal surface of a bulk container during use.

The term “interior ply”, as used herein, refers to the portion of the liner sidewall that forms an interior surface of the enclosed liner and directly contacts product that is packaged in the liner.

The term “intermediate ply”, as used herein, refers to the portion of the liner sidewall that does not reside on either major outer surface of the liner sidewall. The intermediate ply is positioned between an exterior ply and an interior ply such that no contact is made with a product that is packaged in the liner.

The term “polymer”, as used herein, refers to the product of a polymerization reaction, and is inclusive of homopolymers, copolymers, terpolymers, etc. In general, the layers of a film can consist essentially of a single polymer, or can have still additional polymers together therewith, i.e., blended polymers.

The term “film”, as used herein, refers to a material with a very high ratio of length or width to thickness. A film has two major surfaces defined by the length and width. Films typically have good flexibility and can be used for a wide variety of applications, including flexible packaging. Films may also be of thickness or material composition such that they are semi-rigid or rigid. Films described herein are composed of various polymeric materials but may also contain other materials such as metals or papers. Films may be formed as being monolayer or multilayer.

The term “layer”, as used herein, refers to a thickness of material within a film that has a relatively consistent formula. Layers may be of any type of material including polymeric, cellulosic, and metallic or a blend thereof. A given polymeric layer may consist of a single polymer-type or a blend of polymers and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

Any of the exterior ply, the interior ply and the intermediate ply may each be a multilayer film and may include as many layers as necessary to arrive at the desired thickness, performance or other desired properties of the ply. Each ply may include, one layer, two layers, three layers, four layers, five layers, six layers, seven layers, eight layers, nine layers, ten layers, eleven layers, twelve layers, thirteen layers, and so on.

The exterior ply, the interior ply, and any intermediate ply may be produced via any known means. Multilayer plies may be created and combined by way of a multilayer coextrusion process. All, some or none of the layers may be combined by coextrusion. Layers and materials may be added to the ply film by means of adhesive lamination, extrusion coating, vacuum metallization, solution coating, or printing. Other known processes may be utilized in production of the ply as long as the spirit of embodiments disclosed herein is met.

The terms “coextruded”, “coextrude”, or “coextrusion”, as used herein, refer to the process of extruding two or more polymer materials through a single die with two or more orifices arranged so that the extrudates merge and weld together into a laminar structure before chilling (i.e., quenching). Examples of coextrusion methods known in the art include, but are not limited to blown film coextrusion, slot cast coextrusion and extrusion coating. The flat die or slot cast process include extruding polymer streams through a flat or slot die onto a chilled roll and subsequently winding the film onto a core to form a roll of film for further processing.

The term “blown film”, as used herein, refers to a film produced by the blown coextrusion process. In the blown coextrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel and then rapidly cooled or quenched by any of various methods known in the art.

Alternatively, multilayer plies be may be created and combined by way of attaching two or more film layers via laminating methods. The terms “attached” or “attaching”, as used herein, refer to adhering two surfaces to one another, such as the planar surfaces of two film layers. Laminating methods include, but are not limited to, thermal lamination, adhesive lamination, extrusion lamination, and extrusion coating. The layers may be joined by a laminating agent. In an embodiment, the laminating agent may be an extrusion laminating agent where the parameters for such lamination are expected to be set by one skilled in the art without undue experimentation.

The plies may have a thickness in the range of 38 microns to 178 microns (1.5 mil to 7.0 mil), 50 microns to 150 microns (2.0 mil to 6.0 mil), 60 microns to 120 microns (2.4 mil to 4.7 mil), or 70 microns to 90 microns (2.7 mil to 4.7 mil). In embodiments where the ply may be a multilayer film, individual layers may have a thickness in the range of 6 microns to 51 microns (0.25 mil to 2.0 mil), 13 microns to 38 microns (0.5 mil to 1.5 mil), or 20 microns to 25 microns (0.8 mil to 1.0 mil).

The adhesion between any of the plies of the sidewall, that is, the exterior ply, the interior ply, and any optional intermediate ply, may be from 0 g/25.4 cm to 50 g/25.4 cm (0 g/in to 50 g/in) according to ASTM F 904-98. A multi-plied sidewall that includes from 0 g/25.4 cm to 50 g/25.4 cm adhesion between any adjacent plies is referred to as having free movement or be freely moving between adjacent plies. The free movement is believed to dissipate shock and vibrational forces more so than a liner that does not include free movement. Adhesion between adjacent plies that is greater than 50 g/25.4 cm can create points or areas where the stress may not be dissipated contributing to flex-crack failure of one or more plies.

The terms “adhere”, “adherence”, “adhesion”, and formatives thereof, as applied to film layers or other components of the present application, are defined as affixing of the subject layer surface to another surface, with or without adhesive, and such that the layers or components are attached to each other and would require a force to separate them.

As used herein, “adjacent” means that there is no intervening material between the components.

The sidewall may be configured as needed for the requirements of the contained product in the liner and the associated bulk container. Non-limiting examples include, a sidewall that includes three sealed edges and a folded edge of the sidewall to form a liner (e.g., when one sidewall is sealed to itself), a sidewall that that forms a pillow bag that includes four sealed edges of the sidewall to another film that is not a sidewall, or a sidewall that forms a pillow bag that includes four sealed edges of the sidewall when sealed to another sidewall (e.g., when two sidewalls are sealed to each other). Seals attach the sidewall to another material at or near the edges of the sidewall and the other material (e.g., itself, another film or another sidewall) forming the liner that includes an inner compartment that can contain a product. The seals may be formed by any known method including adhesive, heat sealing, ultrasonic sealing, RF welding, etc.

The liner may include dimensions suitable for the product to be contained and according to the container (e.g., box, drum, IBC, etc.) that the product-filled liner may be placed into. An exemplary liner may have an inner compartment volume of 1,136 liters (300 gallons) may include dimensions of about 205 cm (81 inches) in width by about 216 cm (85 inches) in length where the dimensions are measured from the edge of the seal nearest the inner compartment to the opposing edge of the seal nearest the inner compartment for each the length and width.

The liner may also include a fitment. A “fitment” is a structure that provides an inlet for product-filling and/or an outlet for dispensing product from the liner. One or more fitments may be affixed through the plies of a sidewall. The fitment may be any structure suitable for sealing product within the liner; for example, a threaded tube may be affixed through the sidewall and a cap can be threaded onto the tube for closure.

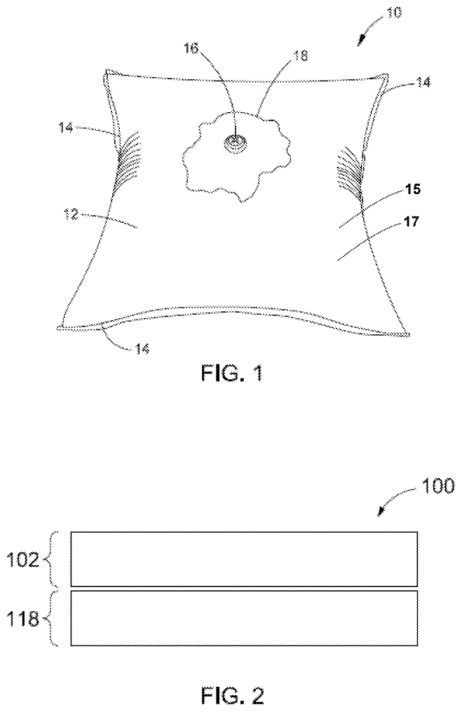

FIG. 1 illustrates a schematic top view of a liner 10 for a bulk container that is in accordance with the embodiments described herein. The liner 10 includes a sidewall 12 that includes seals 14. A fitment 16 is attached to the sidewall 12. The liner 10 may include any number of fitments 16 in the first sidewall 12. The liner 10 includes an inner compartment 15 that can contain a product 17. The liner 10 may include a gas (e.g., air) in the inner compartment 15 along with the product 17 as a result of liner filling and closure mechanisms that do not allow all the gas to be eliminated from the sealed and closed liner 10. In these circumstances, when the product 17 is a liquid product, a shore line 18 is formed at a gas-liquid interface with an interior surface of the sidewall 12.

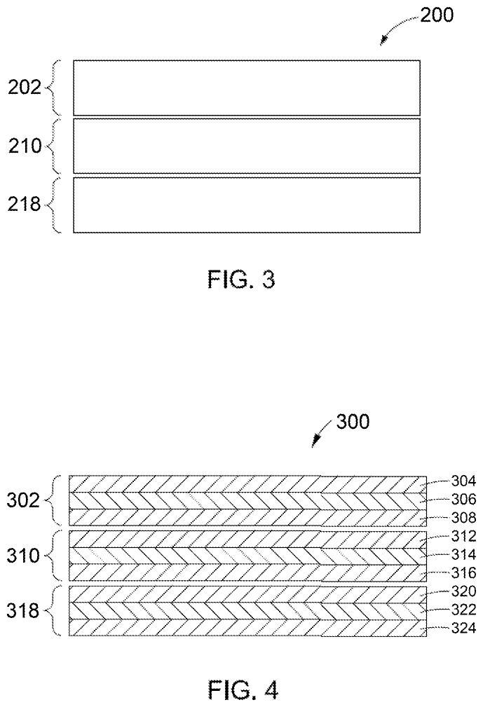

With reference to FIGS. 2-4, schematic cross-sectional views of the sidewall 12 from FIG. 1 are shown. In a first embodiment, FIG. 2 illustrates a sidewall 100 that includes an exterior ply 102 and an interior ply 118. In another embodiment, FIG. 3 illustrates a sidewall 200 that includes an exterior ply 202, an interior ply 218 and an intermediate ply 210. The exterior ply 102, 202, the interior ply 118, 218, and the intermediate ply 210 are shown as monolayer film plies in each embodiment.

In other embodiments, the exterior ply, the interior ply and any intermediate ply may be multilayer films. With reference to FIG. 4, a sidewall 300 is shown. In an embodiment, the sidewall 300 includes an exterior ply 302, an interior ply 318 and an intermediate ply 310 where each of the plies 302, 310, 318 is a multilayer film. The exterior ply 302 includes a first layer 304, a second layer 306, and a third layer 308. In this embodiment, the first layer 304 includes the same material composition as the third layer 308. The second layer 306 that is positioned between the first layer 304 and the third layer 308 includes a different material composition than the first layer 304 and the third layer 308. The interior ply 318 includes a first layer 320, a second layer 322 and a third layer 324. The first layer 320 includes the same material composition as the third layer 324. The second layer 322 that is positioned between the first layer 320 and the third layer 324 includes a different material composition than the first layer 320 and the third layer 324. The intermediate ply 310 includes a first layer 312, a second layer 314 and a third layer 316. The first layer 312 includes the same material composition as the third layer 316. The second layer 314 is positioned between the first layer 312 and the third layer 316 includes a different material composition than the first layer 312 and the third layer 316. In other embodiments where any of the exterior ply, the interior ply and the intermediate ply include multilayer film, each of the first layers, the second layers or the third layers may be compositionally different from each other or any adjacent layer within a ply. In some other embodiments where any of the exterior ply, the interior ply and the intermediate ply include multilayer film, each of the first layers, the second layers or the third layers may be compositionally the same to each other or any adjacent layer within a ply.

In other embodiments, the sidewall may include exterior, interior or intermediate plies that include a combination of plies that are either monolayer film or multilayer film. In another embodiment that includes an exterior ply and an interior ply, i) the exterior ply may be a monolayer film and the interior ply may be a multilayer film or ii) the exterior ply may be a multilayer film and the interior ply may be a monolayer film. In embodiments that also include any number of intermediate plies, any or each of the intermediate plies may be monolayer film or multilayer film. In an embodiment that includes a plurality of intermediate plies, some of the intermediate plies may be monolayer film and the other intermediate plies may be multilayer film. A sidewall structure including plies of monolayer film, multilayer film or a combination of monolayer and multilayer film is within the scope of this disclosure.

In an embodiment, the interior ply includes a propylene alpha-olefin copolymer, which can provide impact and/or fatigue resistance to the liner. In one or more embodiments, the propylene alpha-olefin copolymer includes a density in a range of 0.865 to 0.900 g/cm³. Exemplary propylene alpha-olefin copolymers are ADFLEX Q100, available from Equistar Chemicals, LP, Rotterdam, Netherlands or TAFMER A-4085S, available from Mitsui Chemicals America, Inc., Rye Brook, N.Y., U.S.A. which are polypropylene-based rubber-modified polymers.

In an embodiment, the propylene alpha-olefin copolymer may be present in only the interior ply. In other embodiments, the propylene alpha-olefin copolymer may be present in the interior ply and each of any optional intermediate plies. In another embodiment, the propylene alpha-olefin copolymer may be present in the interior ply and some of any optional intermediate plies. The propylene alpha-olefin copolymer may be present in the interior and any optional intermediate plies in an amount from 5.0% to 50.0%, specifically from 10.0% to 40.0%, and more specifically from 20.0% to 30.0% by weight of the respective ply.

Any ply including the propylene alpha-olefin copolymer, includes a polyethylene blended with the propylene alpha-olefin copolymer. As used herein, “polyethylene” refers to polymers that include an ethylene linkage. Polyethylenes may be a homopolymer, copolymer or interpolymer. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear low density polyethylene (LLDPE), medium-density polyethylene (MDPE), ultra-low density polyethylene (ULDPE), very low density polyethylene (VLDPE), high-density polyethylene (HDPE), metallocene linear low density polyethylene (mLLDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

The polyethylene may include a density in the range from 0.90 g/cm³ to 0.96 g/cm³, specifically from 0.91 g/cm³ to 0.94 g/cm³, and more specifically from 0.92 g/cm³ to 0.93 g/cm³. The polyethylene may be present in an amount from 50.0% to 95.0%, specifically from 40.0% to 80.0%, and more specifically from 50.0% to 70.0% by weight of the respective ply.

Any of the plies, including any ply that includes the propylene alpha-olefin copolymer, can further include processing additives or be blended with other materials, such as, but not limited to, polyolefins, pigments, etc. as is known in the art. The terms “processing aids” or “processing additives”, as used herein, refer to anti-block agents, slip agents, stabilizing agents, release agents, lubricating agents, anti-oxidants, photo-initiators, primers, colorants, oxygen scavengers, and other additives known to and used by a person of ordinary skill in the art without undue experimentation. The use of processing aids varies depending on the equipment, materials, desired properties, etc. Further, each of the exterior ply, the interior ply and any intermediate ply, may be opaque, transparent or have varying degrees thereof. For example, any portion of the ply may be colorant-free, substantially colorant-free, metal-free, substantially metal-free, or substantially free of an additive or other material that would obscure the passage of light.

The inventors have surprisingly found that the inclusion of the propylene alpha-olefin copolymer in the interior and additionally in any optional intermediate plies of the sidewall greatly reduces liner flex-cracking and leakage failure. Further, the propylene alpha-olefin copolymer may contribute towards free movement of adjacent plies and resiliency of the sidewall. Ply shifting (e.g., sliding, gliding, etc.) may dissipate stress away from the shore line or other stress points or areas, including over-seal. The term “over-seal”, as used herein, refers to an area of a seal that extends outside of the area of a sealing bar or apparatus that was used to form the seal. Over-seal can create points or areas of stress initiation in the film plies that reduce or prevent free movement between adjacent plies.

In embodiments that include the propylene alpha-olefin copolymer in the sidewall, the liner may have a flex-crack failure time, without the use of dunnage, of greater than 300 minutes, 325 minutes, 350 minutes, 375 minutes, 400 minutes, 425 minutes, 450 minutes, 475 minutes, 500 minutes, 525 minutes, 550 minutes, 575 minutes, 600 minutes, 625 minutes, 650 minutes, 675 minutes, 700 minutes, 725 minutes, or greater when tested according to a shaker table test described herein. When dunnage is used, the flex-crack failure time may be greater than the flex-crack failure time without the use of dunnage.

In some embodiments, any of the exterior ply, the interior ply or any intermediate plies may further include a polyolefin-silicone copolymer that may contribute to the plies being able to shift against each other that reduces flex-cracking and leakage failure. The term “polyolefin-silicone copolymer”, as used herein, refers to a copolymer comprising polyolefin and silicone. The term “polyolefin”, as used herein, refers to homopolymers or copolymers, including, for example, terpolymers, etc., having a methylene linkage between monomer units which may be formed by any method known to those skill in the art. Non-limiting examples of polyolefins include polyethylene, low density polyethylene, ethylene/propylene copolymers, polypropylene, and propylene/ethylene copolymers. The term “silicone”, as used herein, refers to a polymer generally comprising siloxane-based monomer residue repeating units. The silicone described herein may have a density from 0.9 g/cm³ to 1.0 g/cm³ or from 0.95 g/cm³ to 0.98 g/cm³. Additionally, the silicone may have a kinematic viscosity at 25° C. in the range of from 10×10⁶ to 50×10⁶ centistokes (“cSt”), as determined in accordance with ASTM D445-17a. A non-limiting example of a polyolefin-silicone copolymer is EXFOLA silicone-based surface modifier, available from Mitsui Chemicals America, Inc., Rye Brook, N.Y., U.S.A.

The polyolefin-silicone copolymer may be present in any ply, including those that include the propylene alpha-olefin copolymer, in an amount from 0.1% to 10.0%, specifically from 1.0% to 8.0%, and more specifically from 2.0% to 5.0% by weight of the respective ply.

In some embodiments, a barrier material may be included in the exterior ply, the interior ply or any optional intermediate ply. Barrier materials may be required for some applications where the liner will be used to package product, such as food, in order to preserve quality of the packaged product through distribution and to extend shelf life. In some instances, a moisture barrier is required to prevent a product from drying out (losing moisture content). In other instances, an oxygen barrier is required to prevent ingress oxygen from degrading a product prematurely. In some embodiments, the exterior ply, the interior ply or any intermediate ply may include, but is not limited to, polyamide, polyamide blends, ethylene vinyl alcohol copolymer (EVOH), polyvinyl chloride, polyvinylidene chloride, glass, thermoplastic polyurethane (TPU), polyethylene terephthalate copolymer (PET), high density polyethylene (HDPE), polypropylene, and may include blends thereof. The barrier materials may also include metal, such as aluminum foil, metal coated plastic films, aluminum oxide coated films, silicon dioxide coated films, ceramic coated films, or other barrier coatings as is known in the art. The packaging films that are useful as an oxygen barrier in this application may have an oxygen transmission rate (OTR) value in the range of 0.0-0.20 cm³/100 in² over 24 hours at 80 percent relative humidity (R.H.) and 23° C. Oxygen transmission may be measured according to ASTM D 3985-81. The terms “oxygen transmission rate” or “OTR”, as used herein, refer to the amount of oxygen in cubic centimeters (cm³) that will pass through 100 in² of film in 24 hours at 80 percent R.H and 23° C. (or cm³/100 in² over 24 hours at 80 percent R.H. and 23° C.).

The term “polyamide”, as used herein, refers to a high molecular weight polymer having amide linkages (—CONH—)n which occur along the molecular chain and includes “nylon” resins which are well known polymers having a multitude of uses including utility as packaging films, bags, and casings. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T disclosed at 21 CFR § 177.1500. Examples of polyamides include nylon homopolymers and copolymers such as those selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof. Polyamides are preferably selected from nylon compounds approved for use in producing articles intended for use in processing, handling, and packaging food.

The terms “ethylene vinyl alcohol copolymer” or “EVOH”, as used herein, refer to ethylene-vinyl alcohol copolymer. EVOH is otherwise known as saponified or hydrolyzed ethylene-vinyl acetate copolymer and refers to a vinyl alcohol copolymer having an ethylene comonomer. EVOH copolymers typically used in packaging applications comprise from about 24-48 mole percent ethylene. EVOH can be blended with other materials to modify the properties but is typically used as the single component of a barrier layer. EVOH is commonly used in multilayer packaging films to provide oxygen barrier and is typically incorporated into an inner layer of a multilayer film.

Further, LLDPE or VLDPE layers provide abuse resistance to a ply that is a multilayer film and to the liner as a whole and can be used on either side of an EVOH layer to provide further protection to that ply. Further, a combination (i.e., LLDPE in one layer and VLDPE in another layer) or mixture (i.e., LLDPE and VLDPE combined in a single layer) of LLDPE and VLDPE can be used. Nylon or polyamide-based layers may be interleaved with other layers as desired to provide further strength and protection to a ply.

Tie layers, as generally known by a person of ordinary skill in the art, may be incorporated into the exterior ply, the interior ply or any intermediate ply as appropriate in a multilayer ply. The terms “tie layer”, “adhesive layer” or “adhesive coating”, as used herein, refer to a material placed on one or more layers, partially or entirely, to promote the adhesion of that layer, to another surface. Preferably, adhesive layers or coatings are positioned between two layers of a multilayer film to maintain the two layers in position relative to each other and prevent undesirable delamination. Unless otherwise indicated, a tie layer, adhesive layer or coating can have any suitable composition that provides a desired level of adhesion with the one or more surfaces in contact with the adhesive layer material.

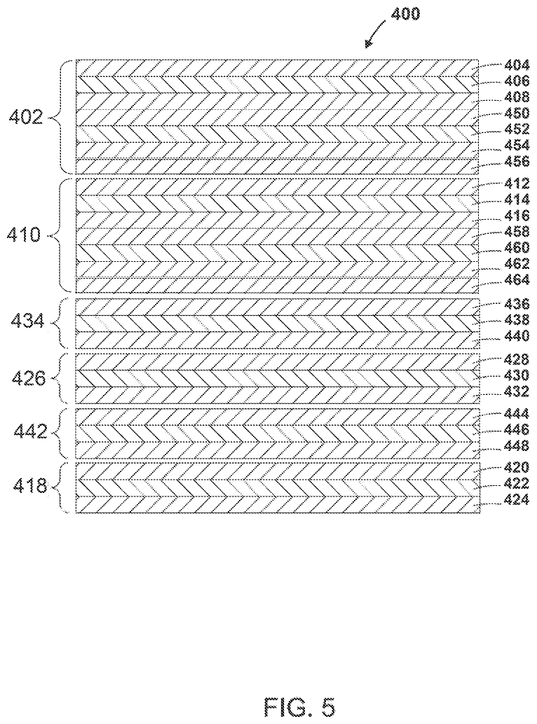

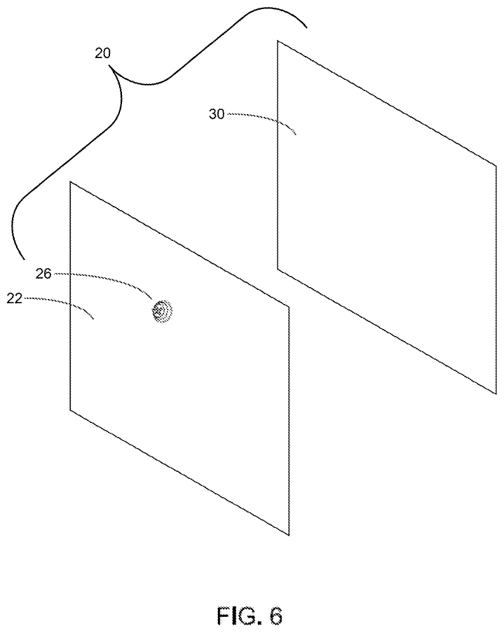

In another embodiment, a sidewall may include an exterior ply that may include a multilayer film that includes seven layers. With reference to FIG. 5, a sidewall 400 is shown that includes six plies that include an exterior ply 402 and an interior ply 418. Sidewall 400 includes multiple intermediate plies that include a first intermediate ply 410, a second intermediate ply 434, a third intermediate ply, 426, and a fourth intermediate ply 442 that are positioned between the exterior ply 402 and the interior ply 418 in sequence from the exterior ply 402. The exterior ply 402 includes a first layer 404, a second layer 406, a third layer 408, a fourth layer 450, a fifth layer 452, a sixth layer 454, a seventh layer 456, and appropriate tie layers as known to one of skill in the art that are not shown. The first layer 404 includes a blend of polyethylene, for example, LLDPE, and a polyolefin-silicone copolymer, the second layer 406 includes polyethylene, for example, LLDPE, the third layer 408 includes polyamide, the fourth layer 450 includes EVOH, the fifth layer 452 includes polyamide, the sixth layer 454 includes polyethylene, for example, LLDPE, and the seventh layer 456 includes a blend of polyethylene, for example, LLDPE, and a polyolefin-silicone copolymer. The first intermediate ply 410 includes a first layer 412, a second layer 414, a third layer 416, a fourth layer 458, a fifth layer 460, a sixth layer 462, a seventh layer, 464, and appropriate tie layers as known to one of skill in the art that are not shown. The first layer 412 includes a blend of polyethylene, for example, LLDPE, and a polyolefin-silicone copolymer, the second layer 414 includes polyethylene, for example, LLDPE, the third layer 416 includes polyamide, the fourth layer 458 includes EVOH, the fifth layer 460 includes polyamide, the sixth layer 462 includes polyethylene, for example, LLDPE, and the seventh layer 464 includes a blend of polyethylene, for example, LLDPE, and a polyolefin-silicone copolymer. The second intermediate ply 434 includes a first layer 436, a second layer 438 and a third layer 440. The third intermediate ply 426 includes a first layer 428, a second layer 430 and a third layer 432. The fourth intermediate ply 442 includes a first layer 444, a second layer 446 and a third layer 448. The interior ply 418 includes a first layer 420, a second layer 422 and a third layer 424. The first layer 436, 428, 444, 420 of the second intermediate ply 434, the third intermediate ply 426, the fourth intermediate ply 442, and the interior ply 418, respectively, include a blend of polyethylene, for example, mLLDPE, and a propylene alpha-olefin copolymer. The second layer 438, 430, 446, 422 of the second intermediate ply 434, the third intermediate ply 426, the fourth intermediate ply 442, and the interior ply 418, respectively, include a blend of polyethylene, for example, mLLDPE, and a propylene alpha-olefin copolymer. The third layer 440, 432, 448, 424 of the second intermediate ply 434, the third intermediate ply 426, the fourth intermediate ply 442, and the interior ply 418, respectively, include a blend of polyethylene, for example, mLLDPE, and a propylene alpha-olefin copolymer.

In another embodiment that includes six plies that is similar to the sidewall 400 and is not shown, a sidewall includes an exterior ply, a first intermediate ply, a second intermediate ply, a third intermediate ply, a fourth intermediate ply, and an interior ply. The first layer and the seventh layer of each of the exterior ply and the first intermediate ply do not include the polyolefin-silicone copolymer. All other layers of the exterior ply and the first intermediate ply are the same as described for the sidewall 400. The second intermediate ply, the third intermediate ply, the fourth intermediate ply and the interior ply are the same as described for the sidewall 400.

In any embodiment, the sidewall includes the exterior ply and the interior ply. The interior ply includes the propylene alpha-olefin copolymer. The sidewall may include any number of optional intermediate plies. Any, all or none of the intermediate plies, when present, may include the propylene alpha-olefin copolymer.

In another embodiment, a liner may include a first sidewall and a second sidewall. The first sidewall includes a first exterior ply, a first interior ply and may optionally include a first sidewall intermediate ply or multiple first sidewall intermediate plies. The second sidewall includes a second exterior ply, a second interior ply and may optionally include a second sidewall intermediate ply or multiple second sidewall intermediate plies. The first exterior ply, the first interior ply, any of the first sidewall intermediate plies, the second exterior ply, the second interior ply, any of the second sidewall intermediate plies may be monolayer film or multilayer film. In embodiments where a ply includes a multilayer film, the multilayer film may include as many layers as necessary for desired properties. The materials, configurations and thickness of the first exterior ply, the first interior ply, any optional first sidewall intermediate plies, the second exterior ply, the second interior ply, and any optional second sidewall intermediate plies correspond to the materials, configurations and thickness that were described for the previously disclosed sidewall that includes the exterior ply, the interior ply and any optional intermediate plies.

In an embodiment, the first sidewall and the second sidewall may include the same number of plies. In another embodiment, the first sidewall may include a greater number of plies than the second sidewall. In yet another embodiment, the first sidewall may include a fewer number of plies than the second sidewall. The number of plies and the composition of the film or layers in a multilayer film in each of the first sidewall and the second sidewall may be determined with respect to the product to be contained, the volume of product to be contained, the bulk container in which the liner will be placed, the method of shipping, the shipping time, or a combination of any of these aspects. Embodiments that include a first sidewall and a second sidewall allow for the propylene alpha-olefin copolymer to be present in both the first sidewall and the second sidewall. The inclusion of propylene alpha-olefin copolymer in the second sidewall may further contribute to the reduction in flex-cracking and leakage failure of the liner. In any embodiment, the adhesion between adjacent plies of either the first sidewall (e.g., first exterior ply, the first interior ply and any first sidewall intermediate plies) or the second sidewall (e.g., the second exterior ply, the second interior ply and any second sidewall intermediate plies) may be from 0 g/25.4 cm to 50 g/25.4 cm (0 g/in to 50 g/in) according to ASTM F 904-98.

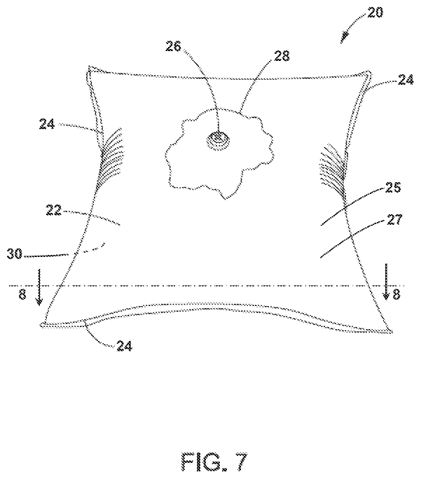

With reference to FIGS. 6-8, another embodiment of a liner is shown. FIG. 6 includes an expanded view of a liner 20 including a first sidewall 22 and a second sidewall 30. The first sidewall 22 includes a fitment 26. The liner may include any number of fitments in the first sidewall, the second sidewall or both the first sidewall and the second sidewall. The first sidewall 22 and the second sidewall 30 may be sealed to each other at or near the edges of each of the first sidewall 22 and the second sidewall 30 to form the liner 20 as shown in FIG. 7. An inner compartment of the liner 25 is located between the first sidewall 22 and the second sidewall 30 such that a product 27 can be contained in the liner 20. A shore line 28 can be formed at a gas-liquid interface within the liner 20 when containing product 27 that includes liquid.

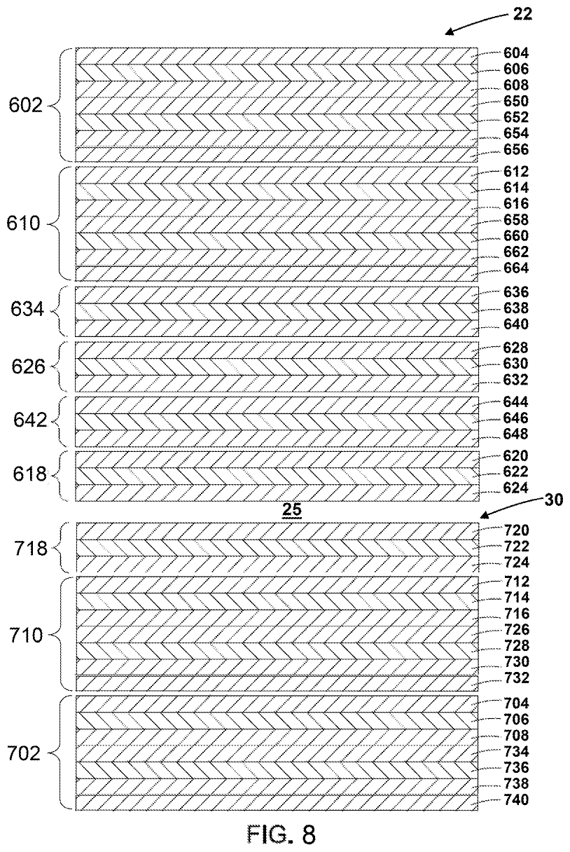

FIG. 8 includes an embodiment of a first sidewall and a second sidewall where schematic cross-sectional views of the sidewalls are shown. The cross-sectional views are along line 8-8 of the first sidewall 22 and the second sidewall 30 of FIG. 7. A first sidewall 22 is shown that includes an exterior ply 602 and an interior ply 618. First sidewall 22 includes multiple intermediate plies that include a first first sidewall intermediate ply 610, a second first sidewall intermediate ply 634, a third first sidewall intermediate ply, 626, and a fourth first sidewall intermediate ply 642 that are positioned between the exterior ply 602 and the interior ply 618 in sequence from the exterior ply 602. The exterior ply 602 includes a first layer 604, a second layer 606, a third layer 608, a fourth layer 650, a fifth layer 652, a sixth layer 654, a seventh layer 656, and appropriate tie layers as known to one of skill in the art that are not shown. The first layer 604 includes a polyethylene, for example, LLDPE, the second layer 606 includes polyethylene, for example, LLDPE, the third layer 608 includes polyamide, the fourth layer 650 includes EVOH, the fifth layer 652 includes polyamide, the sixth layer 654 includes polyethylene, for example, LLDPE, and the seventh layer 656 includes a polyethylene, for example, LLDPE. The first intermediate ply 610 includes a first layer 612, a second layer 614, a third layer 616, a fourth layer 658, a fifth layer 660, a sixth layer 662, a seventh layer, 664, and appropriate tie layers as known to one of skill in the art that are not shown. The first layer 612 includes a polyethylene, for example, LLDPE, the second layer 614 includes polyethylene, for example, LLDPE, the third layer 616 includes polyamide, the fourth layer 658 includes EVOH, the fifth layer 660 includes polyamide, the sixth layer 662 includes polyethylene, for example, LLDPE, and the seventh layer 664 includes a polyethylene, for example, LLDPE. The second intermediate ply 634 includes a first layer 636, a second layer 638 and a third layer 640. The third intermediate ply 626 includes a first layer 628, a second layer 630 and a third layer 632. The fourth intermediate ply 642 includes a first layer 644, a second layer 646 and a third layer 648. The interior ply 618 includes a first layer 620, a second layer 622 and a third layer 624. The first layer 636, 628, 644, 620 of the second intermediate ply 634, the third intermediate ply 626, the fourth intermediate ply 642, and the interior ply 618, respectively, include a blend of polyethylene, for example, mLLDPE, and the propylene alpha-olefin copolymer. The second layer 638, 630, 646, 622 of the second intermediate ply 634, the third intermediate ply 626, the fourth intermediate ply 642, and the interior ply 618, respectively, include a blend of polyethylene, for example, mLLDPE, and the propylene alpha-olefin copolymer. The third layer 640, 632, 648, 624 of the second intermediate ply 634, the third intermediate ply 626, the fourth intermediate ply 642, and the interior ply 618, respectively, include a blend of polyethylene, for example, mLLDPE, and the propylene alpha-olefin copolymer.

The second sidewall 30 includes an exterior ply 702 that is a multilayer film, a first second sidewall intermediate ply 710 that is a multilayer film and an interior ply 718 that is a multilayer film. The interior ply 718 includes a first layer 720, a second layer 722 and a third layer 724. The first layer 720, the second layer 722 and the third layer 724 each include a blend of polyethylene, for example, mLLDPE, and the propylene alpha-olefin copolymer. The first second sidewall intermediate ply 710 includes a first layer 712, a second layer 714, a third layer 716, a fourth layer 728, a fifth layer 728, a sixth layer 730, and a seventh layer 732. The second sidewall exterior ply 702 includes a first layer 704, a second layer 706, a third layer 708, a fourth layer 734, a fifth layer 736, a sixth layer 738, and a seventh layer 740. The first layer 712, 704 of each of the first second sidewall intermediate ply 710 and the exterior ply 702 each include polyethylene, for example, LLDPE. The second layer 714, 706 of each of the first second sidewall intermediate ply 710 and the exterior ply 702 each include polyethylene, for example, LLDPE. The third layer 716, 708 of each of the first second sidewall intermediate ply 710 and the exterior ply 702 each include polyamide. The fourth layer 726, 734 of each of the first second sidewall intermediate ply 710 and the exterior ply 702 each include EVOH. The fifth layer 728, 736 of each of the first second sidewall intermediate ply 710 and the exterior ply 702 each include polyamide. The sixth layer 730, 738 of each of the first second sidewall intermediate ply 710 and the exterior ply 702 each include polyethylene, for example LLDPE. The seventh layer 732, 740 of each of the first second sidewall intermediate ply 710 and the exterior ply 702 each include polyethylene, for example LLDPE.

In any embodiment that includes a first sidewall and a second sidewall, any ply that includes multilayer film may include at least two layers and any number of layers to achieve the desired properties of the ply, sidewall or liner. The layers of each ply may include any composition to achieve the desired properties of the ply, sidewall or liner such that the interior ply includes a propylene alpha-olefin copolymer.

The liner 20 may include dimensions suitable for the product to be contained and according to the container (e.g., box, drum, IBC, etc.) that the product-filled liner may be placed into. The liner 20 may include an inner compartment 25 volume of 1,136 liters (300 gallons) and may include dimensions of about 205 cm (81 inches) in width by about 216 cm (85 inches) in length where the dimensions are measured from the edge portion of the seal 24 that is nearest the inner compartment 25 to the opposing edge portion of the seal 24 nearest the inner compartment 25 for each the length and width.

In embodiments where the liner includes the first sidewall and the second sidewall, the first sidewall may include a first propylene alpha-olefin copolymer. The second sidewall may include a second propylene alpha-olefin copolymer. In some embodiments, the second propylene alpha-olefin copolymer may be the same propylene alpha-olefin copolymer suitable for use as the first propylene alpha-olefin copolymer. Non-limiting examples of the first and second propylene alpha-olefin copolymer are those previously described as being suitable for embodiments that include a single sidewall.

The first propylene alpha-olefin copolymer may be present in the first interior ply and the second propylene alpha-olefin copolymer may be present in the second interior ply. The first propylene alpha-olefin copolymer may additionally be present in any optional first sidewall intermediate plies. The second propylene alpha-olefin copolymer may additionally be present in any optional second sidewall intermediate plies. The first or second propylene alpha-olefin copolymer may be present in any of the plies of the respective first or second sidewall in an amount from 5.0% to 50.0%, specifically from 10.0% to 40.0%, and more specifically from 20.0% to 30.0% by weight of the respective ply.

In embodiments where the liner includes a first and a second sidewall, the liner may have a flex-crack failure time, without the use of dunnage, of greater than 300 minutes, 325 minutes, 350 minutes, 375 minutes, 400 minutes, 425 minutes, 450 minutes, 475 minutes, 500 minutes, 525 minutes, 550 minutes, 575 minutes, 600 minutes, 625 minutes, 650 minutes, 675 minutes, 700 minutes, 725 minutes, or greater when tested according to the shaker table test described herein. When dunnage is used, the flex-crack failure time may be greater than the flex-crack failure time without the use of dunnage.

### Test Methods

Flex-crack failure time is a measure of the time it takes for a liner to experience leakage due to flex-cracking of the sidewall material. A shaker table test is used to simulate transit conditions of a liner when filled with product. The shaker table test is conducted according to ASTM D 999-08, Method A2, Repetitive Shock Test (Rotary Motion). An appropriate shaker table model includes Model V6000, available from L.A.B. Equipment, Inc., Itasca, Ill., USA. An IBC that can hold a 300-gallon liner that is made of plywood and includes dimensions of 41.25 inches by 45 inches by 38.25 inches (104.78 cm by 114.30 cm by 97.15 cm) is used. The IBC is available from Johnston Trading, Woodland, Calif., USA. The 300 gallon liner and the IBC are weighed. The liner is placed into the IBC. Liners that include fitments are placed with the fitment being positioned at the top of the IBC. The liner is filled with water to a water weight of 1,089 kg (2,400 lb). The liner is closed (either with a fitment or seal depending on the type of liner) and any moisture is wiped from the exterior of the liner. For samples that include dunnage, a smooth surface, open cell foam (compressible) that is 41.25 inches by 45 inches by 1 inch (25.4 cm) is placed on top of the liner in the IBC. For samples that include dunnage, the weight of the liner, the IBC and the dunnage are taken. The IBC lid is secured. The IBC is then placed onto the shaker table. The table is run at a frequency that provides 190 revolutions per minute (rpm). The IBC is inspected at periodic intervals until liner leakage is detected. The flex-crack failure time is the time at which leakage occurs. The results of the tests for each sample of the same liner tested under the same conditions are averaged. The average time is reported as the flex-crack failure time for that set of samples.

### EXAMPLES

Various coextruded film plies were configured into first and second sidewalls. Each ply thickness ranged from 50.8 microns to 107.9 microns (2.0 mil to 4.25 mil). The first and second sidewalls were sealed to make liners with a volume of 300 gallons in the form of a pillow bag. A fitment was attached to the first sidewall. The liners were irradiated at a 1.5 MRads dosage as is known by one of skill in the art for sterilization purposes. The liners were tested for flex-crack failure according to the shaker table test method disclosed herein. The Comparative Example and Example Liner structures and overall sidewall thicknesses are included in TABLE 1. Flex-crack failure times, dunnage conditions and remarks are included in TABLE 2.

The various ply compositions and thicknesses included:

A=LLDPE/metallized PET/LLDPE; 4.25 mil

B=LLDPE/LLDPE/polyamide/EVOH/polyamide/LLDPE/LLDPE; 2.25 mil

C=LLDPE+polyolefin-silicone copolymer (2% by wt. of the ply)/LLDPE/polyamide/EVOH/polyamide/LLDPE/LLDPE+polyolefin-silicone copolymer (2% by wt. of the ply); 2.75 mil

D=LLDPE/LLDPE/LLDPE; 2.75 mil

E=LLDPE/EVOH/LLDPE; 2.75 mil

F=mLLDPE+propylene alpha-olefin copolymer (30% by wt. of the ply)/mLLDPE+propylene alpha-olefin copolymer (30% by wt. of the ply)/mLLDPE+propylene alpha-olefin copolymer (30% by wt. of the ply); 2.00 mil

F′=mLLDPE+propylene alpha-olefin copolymer (30% by wt. of the ply)/mLLDPE+propylene alpha-olefin copolymer (30% by wt. of the ply)/mLLDPE+propylene alpha-olefin copolymer (30% by wt. of the ply); 2.75 mil

G=mLLDPE/mLLDPE+propylene alpha-olefin copolymer (30% by wt. of the ply)/mLLDPE; 2.0 mil

H=mLLDPE+propylene alpha-olefin copolymer (30% by wt. of the ply)/mLLDPE/mLLDPE+propylene alpha-olefin copolymer (30% by wt. of the ply); 2.0 mil

Ply A includes layers that are adhesively laminated.

Plies D, E, F, F′, G, and H are coextruded, multilayer films including a first layer, a second layer and a third layer as described herein.

Plies B and C are coextruded, multilayer films that also include tie layers as necessary.

TABLE 1*

| | First | Second |
|---|---|---|
| Code | Sidewall | Sidewall |
| Comparative | Exterior Ply = A | Exterior Ply = A |
| Example 1 | Intermediate Ply (1) = E | Intermediate Ply (1) = E |
| | Interior Ply = E | Interior Ply = E |
| Comparative | Exterior Ply = B | Exterior Ply = B |
| Example 2 | Intermediate Ply (1) = B | Intermediate Ply (1) = B |
| | Intermediate Ply (2) = E | Intermediate Ply (2) = E |
| | Interior Ply = D | Interior Ply = D |
| Comparative | Exterior Ply = C | Exterior Ply = C |
| Example 3 | Intermediate Ply (1) = C | Intermediate Ply (1) = C |
| | Intermediate Ply (2) = E | Intermediate Ply (2) = E |
| | Interior Ply = D | Interior Ply = D |
| Example 1 | Exterior Ply = C | Exterior Ply = C |
| | Intermediate Ply (1) = C | Intermediate Ply (1) = C |
| | Intermediate Ply (2) = F′ | Interior Ply = F′ |
| | Intermediate Ply (3) = F′ | |
| | Intermediate Ply (4) = F′ | |
| | Interior Ply = F′ | |
| Example 2 | Exterior Ply = C | Exterior Ply = C |
| | Intermediate Ply (1) = C | Intermediate Ply (1) = C |
| | Intermediate Ply (2) = F | Interior Ply = F |
| | Intermediate Ply (3) = F | |
| | Intermediate Ply (4) = F | |
| | Interior Ply = F | |
| Example 3 | Exterior Ply = C | Exterior Ply = C |
| | Intermediate Ply (1) = C | Intermediate Ply (1) = C |
| | Intermediate Ply (2) = G | Interior Ply = G |
| | Intermediate Ry (3) = G | |
| | Intermediate Ply (4) = G | |
| | Interior Ply = G | |
| Example 4 | Exterior Ply = C | Exterior Ply = C |
| | Intermediate Ply (1) = C | Intermediate Ply (1) = C |
| | Intermediate Ply (2) = H | Interior Ply = H |
| | Intermediate Ply (3) = H | |
| | Intermediate Ply (4) = H | |
| | Interior Ply = H | |
| Example 5 | Exterior Ply = C | Exterior Ply = C |
| | Intermediate Ply (1) = C | Intermediate Ply (1) = C |
| | Intermediate Ply (2) = H | Interior Ply = H |
| | Intermediate Ply (3) = H | |
| | Intermediate Ply (4) = H | |
| | Interior Ply = H | |

*Note:
the plies are listed in sequential order as configured in the sidewall. For instance, the First Sidewall in Example 5 includes Intermediate Ply (1) positioned between the Exterior Ply and Intermediate Ply (2), Intermediate Ply (2) positioned between Intermediate Ply (1) and Intermediate Ply (3), and Intermediate Ply (3) positioned between Intermediate Ply (2) and the Interior Ply. For the Second Sidewall, Intermediate Ply (1) is positioned between the Exterior Ply and the Interior Ply. The Interior Ply of the First and Second Sidewall face each other in the liner configuration.

TABLE 2

| | Sidewall Thickness | Flex-Crack | Tested | |
|---|---|---|---|---|
| | First, Second, Total | Failure Time | with | |
| Code | (mil, microns) | (minutes) | Dunnage | Remarks |
| Comparative | 247.65, 247,65, 495.3 | 144 | Yes | Metallized barrier, |
| Example 1 | 9.75, 9.75, 19.5 | | | commercial standard, 3- |
| | | | | ply sidewalls |
| Comparative | 254.0, 254.0, 508.0 | 125 | Yes | Includes EVOH and |
| Example 2 | 10.0, 10.0, 20.0 | | | polyamide, 4-ply |
| | | | | sidewalls |
| Comparative | 279.4, 279.4, 558.8 | 175 | Yes | Includes EVOH and |
| Example 3 | 11.0, 110, 22.0 | | | polyolefin-silicone |
| | | | | copolymer, 4-ply |
| | | | | sidewalls |
| Example 1 | 419.1, 209.5, 628,6 | 690** | No | Includes propylene alpha- |
| | 16.5, 8.25, 24.75 | | | olefin copolymer in all |
| | | | | layers of plies that |
| | | | | include propylene alpha- |
| | | | | olefin copolymer and |
| | | | | polyolefin-silicone |
| | | | | copolymer, 6- and 3-ply |
| | | | | sidewalls |
| Example 2 | 342.9, 190.5, 533.4 | 730** | No | Includes propylene alpha- |
| | 13.5, 7.5, 21.0 | | | olefin copolymer in all |
| | | | | layers of plies that |
| | | | | include propylene alpha- |
| | | | | olefin copolymer and |
| | | | | polyolefin-silicone |
| | | | | copolymer, 6- and 3-ply |
| | | | | sidewalls |
| Example 3 | 342.9, 190.5, 533.4 | 730** | No | Includes propylene alpha- |
| | 13.5, 7.5, 21.0 | | | olefin copolymer in |
| | | | | second layer of plies that |
| | | | | include propylene alpha- |
| | | | | olefin copolymer and |
| | | | | polyolefin-silicone |
| | | | | copolymer, 6- and 3-ply |
| | | | | sidewalls |
| Example 4 | 342.9, 190.5, 533.4 | 710** | No | Includes propylene alpha- |
| | 13.5, 7.5, 21.0 | | | olefin copolymer in first |
| | | | | and third layers of plies |
| | | | | that include propylene |
| | | | | alpha-olefin copolymer |
| | | | | and polyolefin-silicone |
| | | | | copolymer, 6- and 3-ply |
| | | | | sidewalls |
| Example 5 | 342.9, 190.5, 533.4 | 700** | No | Includes propylene alpha- |
| | 13.5, 7.5, 21.0 | | | olefin copolymer in first |
| | | | | and third layers of plies |
| | | | | that include propylene |
| | | | | alpha-olefin copolymer |
| | | | | and polyolefin-silicone |
| | | | | copolymer, 6- and 3-ply |
| | | | | sidewalls |

**Note:
Examples 1 through 5 did not fail. The flex-crack failure times reported in TABLE 2 for these examples indicate the time that passed when the samples were removed from the testing device.

Comparative Example 1 is representative of a 3-ply sidewall, commercial liner that includes a ply of metallized polyester in each sidewall. The terms “polyester” or “PET”, as used herein, refer to a homopolymer or copolymer having an ester linkage between monomer units. Polyesters may include a homopolymer or copolymer of alkyl-aromatic esters, including but not limited to polyethylene terephthalate (PET), amorphous polyethylene terephthalate (APET), polyethylene furanoate (PEF), glycol-modified polyethylene terephthalate (PETG), and polybutylene terephthalate (PBT): a copolymer of terephthalate and isophthalate including but not limited to polyethylene terephthalate/isophthalate copolymer, such as isophthalic acid (IPA) (modified polyethylene terephthalate (PETI)); a homopolymer or copolymer of aliphatic esters including but not limited to polylactic acid (PLA), polyglycolic acid (PGA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); and blends of any of these materials.

Comparative Example 2 includes 4-ply sidewalls where each include EVOH and polyamide and is free of metallized polyester. Comparative Example 3 includes 4-ply sidewalls where each sidewall includes EVOH and polyolefin-silicone copolymer. Examples 1 through 5 include a 6-ply first sidewall and a 3-ply second sidewall where each sidewall includes propylene alpha-olefin copolymer, EVOH and polyolefin-silicone copolymer. Example 1 differs in thickness from Examples 2 through 5. Examples 1 and 2 include propylene alpha-olefin copolymer in the first, second and third layers of the plies that include propylene alpha-olefin copolymer. Example 3 includes propylene alpha-olefin copolymer in the second layer of the plies that include propylene alpha-olefin copolymer. Examples 4 and 5 include propylene alpha-olefin copolymer in the first and third layers of the plies that include propylene alpha-olefin copolymer.

The Comparative Examples 1-3 were tested with dunnage and failed at flex-crack failure times that much lower than the times reported for Examples 1-5. The times reported for Examples 1-5 represent when the samples were removed from the testing apparatus and do not represent time to true failure (see Note**).

Comparative Example 3 includes EVOH and polyolefin-silicone copolymer and relatively similar overall thickness to Examples 2-5 and displayed significantly lower flex-crack failure times than Examples 2-5 that include propylene alpha-olefin copolymer, EVOH and polyolefin-silicone copolymer.

Example 1 and 2 include the same ply composition in each sidewall, however the plies in Example 1 that include the propylene alpha-olefin copolymer are thicker (69.85 microns, 2.75 mil) than the plies that include propylene alpha-olefin copolymer in Example 2 (50.8 microns, 2.0 mil). The flex-crack failure time for Example 1 and Example 2 are 690 and 730 minutes, respectively. The thicker propylene alpha-olefin copolymer containing plies of Example 1 appear to contribute to liner performance similarly to the thinner propylene alpha-olefin copolymer containing plies of Example 2

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention. The disclosure is capable of other embodiments and of being practiced or being carried out in various ways.

1. A liner for a bulk container comprising:
a sidewall comprising an exterior ply and an interior ply;
wherein the interior ply comprises a propylene alpha-olefin copolymer, wherein the propylene alpha-olefin copolymer comprises a density in a range from 0.865 g/cm³ to 0.900 g/cm³, and wherein the interior ply comprises the propylene alpha-olefin copolymer in an amount from 5% to 50% by weight of the interior ply.

2. The liner of claim 1, further comprising a fitment attached to the sidewall.

3. The liner of claim 1, wherein the interior ply further comprises a first polyethylene comprising low density polyethylene, linear low density polyethylene, very low density polyethylene, ultra-low density polyethylene, medium density polyethylene, high density polyethylene, metallocene linear low density polyethylene or blends thereof.

4. The liner of claim 1, further comprising a flex crack failure time of greater than 300 minutes according to ASTM D 999-08, Method A2, as described herein.

5. The liner of claim 1, further comprising an intermediate ply positioned between the exterior ply and the interior ply and wherein the adhesion between adjacent plies comprises from 0 g/25.4 cm to 50 g/25.4 cm (0 g/n to 50 g/n) according to ASTM F 904-98.

6. The liner of claim 1, wherein the intermediate ply comprises a propylene alpha-olefin copolymer in an amount from 5% to 50% by weight of the intermediate ply.

7. The liner of claim 1, wherein the exterior ply, the interior ply and the intermediate ply are multilayered.

8. The liner of claim 7, wherein the exterior ply, the interior ply or the intermediate ply are produced by coextrusion.

9. The liner of claim 7, wherein the exterior ply, the interior ply or the intermediate ply comprise a laminated film.

10. The liner of claim 1, wherein the exterior ply, the interior ply or the intermediate ply comprise an oxygen barrier comprising ethylene vinyl alcohol copolymer or polyamide.

11. A liner for a bulk container comprising:
a first sidewall comprising a first exterior ply and a first interior ply; and
a second sidewall comprising a second exterior ply and a second interior ply;
wherein the first interior ply comprises a first propylene alpha-olefin copolymer comprising a density in a range from 0.865 g/cm³ to 0.900 g/cm³ in an amount of 5% to 50% by weight of the first interior ply, and wherein the second interior ply comprises a second propylene alpha-olefin copolymer comprising a density in a range from 0.865 g/cm³ to 0.900 g/cm³ in an amount of 5% to 50% by weight of the second interior ply.

12. The liner of claim 11, further comprising a fitment attached to the first sidewall.

13. The liner of claim 11, wherein the liner comprises a flex crack failure time of greater than 500 minutes according to ASTM D 999-08, Method A2, as described herein.

14. The liner of claim 11, further comprising a first intermediate ply positioned between the first exterior ply and the first interior ply wherein the adhesion between any adjacent ply comprises from 0 g/25.4 cm to 50 g/25.4 cm (0 g/n to 50 g/n) according to ASTM F 904-98.

15. The liner of claim 11, further comprising a second intermediate ply positioned between the second exterior ply and the second interior ply wherein the adhesion between any adjacent ply comprises from 0 g/25.4 cm to 50 g/25.4 cm (0 g/n to 50 g/n) according to ASTM F 904-98.

16. The liner of claim 11, wherein the first intermediate ply and the second intermediate ply each comprise a propylene alpha-olefin copolymer in an amount from 5% to 50% by weight of the first intermediate ply and the second intermediate ply.
